(19) United States
(12) Patent Application Publication
(10) Pub. No.: US 2010/0146599 A1
(43) Pub. Date: Jun. 10, 2010

(54) CLIENT-BASED GUEST VLAN

(75) Inventors: Kishore Padmanabha, Morrisville, NC (US); Colin Winegarden, Holly Springs, NC (US)

Correspondence Address: BRAKE HUGHES BELLERMANN LLP;c/o CPA Global, P.O. Box 52050, Minneapolis, MN, 55402, US

(73) Assignee: Broadcom Corporation, Irvine, CA (US)

(21) Appl. No.: 12/332,137

(22) Filed: Dec. 10, 2008

(51) Int. Cl. H04L 9/32

(52) U.S. Cl. 726/5

(57) ABSTRACT

A network device connected to a network includes a physical port and multiple logical ports configured to provide guest access or authenticated access to the network via the physical port, to a supplicant device. An authorization engine determines whether the supplicant device is authorized to access the network. An authentication engine determines whether the supplicant device is compatible with an authentication protocol associated with the network based on a receipt or a non-receipt of a response from the supplicant device to one or more authentication requests. A guest table stores the source address of the supplicant device if the supplicant device is authorized to access the network and is incompatible with the authentication protocol, wherein the logical ports are configured to provide the guest access to the supplicant device corresponding to the source address stored in the guest table.

### TECHNICAL FIELD

This description relates to network access.

### BACKGROUND

With the growth in the number and popularity of networks and network devices, network security has become increasingly important. As part of maintaining the security and integrity of a network, a network device may be required to be authorized and/or authenticated before being granted access to a network. Traditional network authentication may provide security on a port basis, whereby if one network device is granted access to the network though a particular network port, then other network devices accessing the network are granted a similar level of access, independent of whether they are authorized to access the network or not, so long as they access the network thought the same port.

### SUMMARY

In a first general aspect, a network device is connected to a network. A physical port may be configured to receive an access message from a supplicant device, for either guest access or authenticated access to the network via the physical port, wherein the guest access is more restrictive than the authenticated access. A plurality of logical ports may be associated with the physical port, wherein each logical port is configured to provide either the guest access or the authenticated access to the supplicant device. An authorization engine may be configured to determine, based on the access message, whether the supplicant device is authorized to access the network. A source identifier may be configured to identify, based on the access message, a source address associated with the supplicant device. An authentication engine may be configured to determine whether the supplicant device is compatible with an authentication protocol associated with the network based on a receipt or a non-receipt of an authentication response from the supplicant device to one or more authentication requests sent to the supplicant device. A guest table may be configured to store the source address of the supplicant device if the supplicant device is authorized to access the network and is incompatible with the authentication protocol, wherein the logical ports are configured to provide the guest access to the supplicant device corresponding to the source address stored in the guest table.

In another general aspect, a method is provided. An access message may be received from a supplicant device requesting access to a network via a logical port, wherein the logical port is configured to provide the supplicant device either authenticated access or guest access to the network. An authentication request may be provided to the supplicant device. The supplicant device may be determined not to be compatible with the authentication protocol based on a failure to receive an authentication response from the supplicant device, in response to the authentication request, within a response period. A source address associated with the supplicant device may be determined from the access message. The source address may be added to a guest table for granting the supplicant device the guest access to the network. The supplicant device may be provided the guest access to the network via the logical port based on the source address remaining in the guest table.

In another general aspect, a switch may be provided. The switch may interface with a network, the network being associated with an authentication protocol for providing authenticated access or a more restrictive guest access to the network to a supplicant device based on a compatibility of the supplicant device with the authentication protocol. The switch may determine the compatibility of the supplicant device with the authentication protocol. The switch may provide, via a logical port of a physical port of the switch associated with the supplicant device, the guest access or the authenticated access to the supplicant device based on the compatibility of the supplicant device with the authentication protocol.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example client-based guest virtual local area network (VLAN) system, according to an example embodiment.

FIG. 2 is a flowchart illustrating example operations of the system of FIG 1.

FIG. 3 is a flowchart illustrating example operations of the system of FIG 1.

FIG. 4 is a communications diagram illustrating example communications of the components of the system of FIG. 1.

FIG. 5 is a communications diagram illustrating example communications of the components of the system of FIG. 1.

FIG. 6 is a communications diagram illustrating example communications of the components of the system of FIG. 1.

FIG. 7 is a computing system diagram illustrating example components of the client-based guest virtual local area network (VLAN) system of FIG. 1, according to an example embodiment.

### DETAILED DESCRIPTION

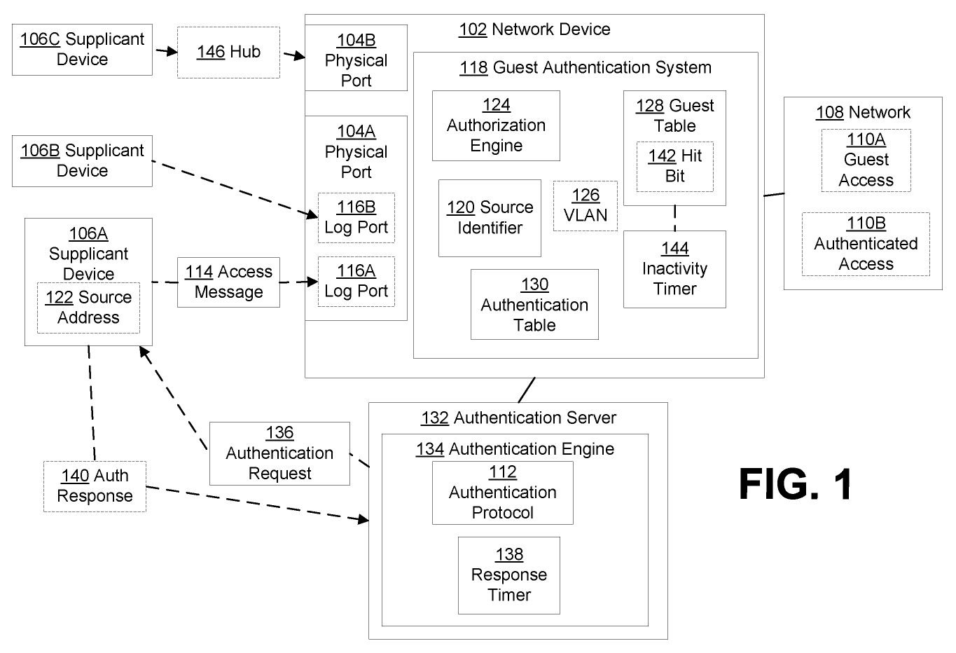

FIG. 1 is a block diagram of an example client-based guest virtual local area network (VLAN) system, according to an example embodiment. In the example of FIG. 1, the system may provide varying levels of access to a network to multiple clients over a physical port based on their compatibility with an authentication protocol associated with the network. Clients that are compatible with the authentication protocol and clients that are incompatible (or otherwise unable to perform in the authentication protocol) may be provided varying levels of access to the network via the same physical port, based, at least in part, on their compatibility.

This may allow, for example, greater network security over a system in which all clients connecting through a port are provided the same access rights or need not each be individually authorized or authenticated to access the network, such as in a port-based authentication protocol. The system of FIG. 1, may allow for a greater ease of administration where each port need not be configured individually based on the level of access to be provided to connecting clients. For example, each port may include a common configuration profile (e.g., allowing a network administrator to avoid configuring each port separately based on the level of access to be provided), as both authentication protocol enabled and non-enabled clients can coexist on a single port and still be granted varying levels of access to the network.

According to an example embodiment a corporate intranet may grant varying levels of access to clients based on their relation to the corporation. For example, corporate employees may receive full access to the network, while contractors and/or visitors may be granted more restricted access. Then for example, if a contractor and employee are meeting in a room and trying to gain network access via the same port, the system of FIG. 1 may provide the varying access and thus maintain the integrity or security of the network.

The system of FIG. 1 may include a network device 102 with one or more physical ports 104A, 104B though which one or more supplicant devices 106A, 106B, 106C may connect to a network 108. The network device 102 may include any device configured to connect or otherwise provide access to the network 108. The network device 102 may, for example, include a switch, router, bridge, hub, gateway or other network device. In other example embodiments, other network devices 102 may be implemented.

The network device 102 may include the physical ports 104A and 104B. The physical ports 104A, 104B may include physical ports by which one or more supplicant device 106A-C may try and access the network 108. For example, the physical ports 104A and 104B may include an interface or outlet on the network device 102, providing for signal transfer between the network 108 and the connected supplicant devices 106A-C.

The supplicant devices 106A-C may include any devices requesting access to the network 108. The supplicant device 106A-C may include, for example, laptops, voice-over internet protocol (VOIP) devices, Bluetooth devices, mobile devices or any other devices seeking either wired or wireless access to the network 108. The supplicant devices 106A-C may include both authorized and unauthorized users on the network 108.

The network 108 may include any wired or wireless telecommunications or computer network. For example, the network 108 may include a local area network (LAN), wide area network (WAN), the Internet, any local or private intranet or other network. The network 108 may be associated with varying levels of access that may be granted, such as guest access 110A and authenticated access 110B that may be provided to the supplicant devices 106A-C based, at least in part, on their compatibility with an authentication protocol 112. In other example embodiments, an access level (e.g., 110A, 110B) may be granted including other factors as well, such as priority, source, and destination.

The supplicant devices 106A-C, as will be discussed below, may be provided any of varying levels of access to the network 108, including, for example, guest access 110A, authenticated access 110B and no access. In other example embodiments other levels of access may be provided. According to an example embodiment, the guest access 110A may include a more restrictive access to one or more features of the network 108 than the authenticated access 110B. For example, devices provided guest access 110A to the network 108 may allowed to connect to one or more other or outside networks (e.g., the Internet) through the network 108 but may not be able to search or perform other actions within the network 108 (which may include a corporate intranet). Then for example, the authenticated access 110B may allow devices to access and/or search internal documents on the network 108 as well as access to other networks, such as the Internet. In other example embodiments, the capabilities allowed by the guest access 110A and authenticated access 110B may vary.

As just referenced, one basis of determining whether a supplicant device 106A-C may be granted the guest access 110A or the authenticated access 110B may be based upon the compatibility of each supplicant device 106A-C with the authentication protocol 112. The authentication protocol 112 may include an authentication framework to determine whether a device trying to access the network 108 includes certain security, encryption or other authentication features. For example, the authentication protocol 112 may include the extensible authentication protocol (EAP) that may be used in wired or wireless LAN authentication.

According to an example embodiment, the authentication protocol 112 may include IEEE 802.1x authentication. The 802.1x authentication may provide, for example, port-based authentication. The 802.1x authentication may require credentials from the supplicant devices 106A-C, such as user names, password, digital certificate or other credentials which may be verified before determining whether the supplicant devices 106A-C are authenticated. Then for example, based on the supplicant devices' 106A-C compatibility and/or verification with the authentication protocol 112, guest access 110A, authenticated access 110B or no access may be granted to the network 108 to each supplicant device 106A-C. In other example embodiments, other authentication protocols may be implemented.

In the example of FIG. 1, the supplicant device 106A, in requesting or otherwise trying to gain access to the network 108, may provide or transmit an access message 114 to the physical port 104A. The access message 114 may be received at a logical port 116A (or 116B) of the physical port 104A at which point a guest authentication system 118 may determine which level of access to provide to the supplicant device 106A.

The access message 114 may include any message, packet, information, stream of packets or other data or indication sent by the supplicant device 106A and received at the physical port 104A. For example, the supplicant device 106A may broadcast, multi-cast or unicast the access message 114 which may be received at the logical port 116 of the physical port 104A of the network device 102. The access message 114 may include source, destination, security, encryption, routing, priority and/or other information that may be read or extracted by the network device 102. The access message 114 may include any packet or other bundle of information intended to access the network 108, including packets intended for other external networks (e.g., that may travel across at least a portion of the network 108).

The guest authentication system 118 may process the access message 114 to determine which level of network access to grant or provide the supplicant device 106A. A source identifier 120 may extract or otherwise determine from the access message 114, a source address 122 corresponding to or otherwise associated with the supplicant device 106A. The source address 122 may include an address, username or other identifier used to identify the supplicant device 106A. For example, the source address 122 may include a media access control (MAC) address corresponding to the supplicant device 106. Then for example, the source identifier 120 may extract the MAC address from the header of the access message 114 to identify the supplicant device 106A.

An authorization engine 124 may determine whether the supplicant device 106A is authorized to access the network 108. The authorization engine 124 may, for example, compare the source address 122 to a list or database of authorized addresses to determine if the supplicant device 106A is authorized to access the network 108. If, for example, the authorization engine 124 determines that the supplicant device 106A is not authorized to access the network 108, then processing of the access message 114 may be halted and the supplicant device 106A may be denied any level of network access. If however the authorization engine 124 determines that the supplicant device 106A is an authorized user of the network 108, then the system of FIG. 1 may continue processing the access message 114 to determine which level of access to grant to the supplicant device 106A.

A virtual local area network (VLAN) component 126 may determine whether the supplicant device 106A has already been granted access to the network 108. For example, the VLAN 126 may compare the source address 122 to a guest table 128 and an authentication table 130 to determine if the supplicant device 106A already has the guest access 110A or the authenticated access 110B. The tables 128 and 130 may include a list or other collection of source addresses (e.g., 122) that may be accessed or otherwise searchable by the VLAN 126. For example, the tables 128 and 130 may include layer 2 (L2) look-up tables. The guest table 128 may include a list of addresses or other identifiers of devices that have been provided the guest access 110A based on prior processing, and the authentication table 130 may include a list of addresses or identifiers of devices that have been provided the authenticated access 110B based on prior processing.

If the VLAN 126 finds the source address 122 active in either the guest table 128 or the authentication table 130, then the VLAN 126 may process the packet or packets from the supplicant device 106A according to the rules or permissions associated with guest access 110A or authenticated access 110B, respectively. If however, the VLAN 126 is unable to find the source address 122 active in either the guest table 128 or the authentication table 130, then an authentication server 132 may continue the processing.

The authentication server 132 may include a server or other network device configured to communicate or otherwise exchange messages with the supplicant device 106A to verify its identity. According to an example embodiment, the authentication server 132 may include a server that communicates with both the network device 102 and the supplicant device 106A. For example, the authentication server 132 may receive a request to authenticate the supplicant device 106A from the network device. Then for example, the authentication server 132 may exchange messages or otherwise attempt to communicate with the supplicant device 106A, and may respond to the network device 102 with the result of the authentication procedure.

The authentication server 132 may include an authentication engine 134 configured to authorize or authenticate the supplicant device's 106A identity. The authentication procedure may be based on one or more authentication protocols 112, including for example, the 802.1x authentication. Upon detection of the new client or supplicant 106A, the authentication engine 134 may set the supplicant device's 106A status as ‘unauthorized’ and thus only allow 802.1x traffic. The authentication engine 134 may send, transmit or otherwise provide to the supplicant device 106A an authentication request 136. The authentication request 136 may include an EAP request as referenced above.

Upon sending the authentication request 136, the authentication engine 134 may begin or reset a response timer 138. The response timer 138 may set or count up to or down from a response period associated with the authentication request 136. The response period may include a period of time for which the authentication engine 134 may wait prior to sending another authentication request 136 and/or determining that the supplicant device 106A is not compatible with the authentication protocol 112. According to an example embodiment, the response period may be 30 seconds, but may vary in other embodiments.

After receipt of the authentication request 136, the supplicant device 106A, if compatible with the authentication protocol 112, may respond with an authentication response 140. The authentication response 140 may include at least some of the information requested by the authentication request 136. It may be, for example, that the authentication engine 134 and supplicant device 106A exchange several messages (e.g., as part of an authentication procedure that may be associated with the authentication protocol 112) before the authentication engine 134 is able to authenticate the identity of the supplicant device 106A.

If however, the supplicant device 106A is not compatible with the authentication protocol 112, then the supplicant device 106A may not respond to the authentication request 136 or otherwise send an authentication response (e.g., 140) that is rejected or otherwise discarded as being incompatible with the authentication protocol 112 by the authentication engine 134. Then for example, upon waiting a response period (as determined by the response timer 138), the authentication engine 134 may send another authentication request 136 to the supplicant device 106A. If after the expiration of one or more response periods and/or the transmittal of one or more authentication requests 136, the authentication engine 134 has not received a valid authentication response 140 from the supplicant device 106A, the authentication engine 134 may determine that the supplicant device 106A is not compatible with the authentication protocol 112.

The authentication server 132 may provide its authentication determination to the guest authentication system 118 which may continue processing the supplicant device's 106A request for access to the network 108. Based on the authentication determination, the guest authentication system 118 may provide the guest access 110A, the authenticated access 110B or no access to the network 108 to the supplicant device 106A. For example, if the authentication engine 134 determines that supplicant device 106A is compatible with the authentication protocol 112 (e.g., the authentication engine 134 received a valid authentication response 140 from the supplicant device 106A) and the authentication engine 134 was able to authenticate the supplicant device 106A, then the guest authentication system 118 may add the source address 122 to the authentication table 130, thus providing the authenticated access 110B to the supplicant device 106A.

If the authentication engine 134 determines that supplicant device 106A is compatible with the authentication protocol 112 but was unable to authenticate the supplicant device 106A, then the guest authentication system 118 may deny access to the network 108 to the supplicant device 106A. If the authentication engine 134 determines that supplicant device 106A is not compatible with the authentication protocol 112 (e.g., the authentication engine 134 did not receive a valid authentication response 140 from the supplicant device 106A before the expiration of the response period), then the guest authentication system 118 may add the source address 122 to the guest table 128, thus providing the guest access 110A to the supplicant device 106A. According to an example embodiment, the system of FIG. 1 may include another table where the source address (e.g., 122) of devices denied access to the network 108 may be stored.

After determining whether the supplicant device 106A is granted guest access 110A or authenticated access 110B and the source address 122 is added to the appropriate table (e.g., 128 or 130, respectively), subsequent packets from the supplicant device 106A may be processed based on the level of access provided. For example, upon receipt of one or more subsequent packets from the supplicant device 106A, the VLAN 126 may look-up the source address 122 associated with the packets in the guest table 128 and/or the authentication table 130 and process the packet appropriately. If the source address 122 already exists in one of the tables 128, 130, then the supplicant device 106A need not be authenticated by the authentication engine 134 and the packets may be processed accordingly.

According to an example embodiment, the guest table 128 may periodically clear addresses from the table. Periodically clearing inactive addresses (e.g., addresses corresponding to supplicant devices 106A-C that have not transmit and/or received packets for a period of time) may save memory in the guest table 128 and provide for greater security within the system.

According to an example embodiment the addresses of the guest table 128 (hereinafter “guest addresses”) may be associated with or otherwise correspond to a hit bit 142. The hit bit 142 may include an indication as to whether or not the associated guest address has been or is active on the network 108. For example, when the supplicant device 106A receives and/or transmits a packet or message to the network 108, the hit bit 142 may be reset to 1. Then for example, if a period of time passes, as determined by an inactivity timer 144, where the supplicant device 106A does not receive and/or transmit a packet (or a minimum number of packets), the corresponding guest address hit bit 142 may be cleared. The inactivity timer 144 may determine when an inactivity period passes and the hit bit 142 may be cleared. For example, after the expiration of a first inactivity period, the hit bit 142, if reset (e.g., set to “1”) for a guest address, may be cleared to “0”. Then for example, after the expiration of a second inactivity period, if the hit bit 142 for the guest address has already been cleared to “0” then the corresponding guest address may be removed or cleared from the guest table 128. Then, the next time a packet is received from the supplicant device 106A corresponding to the previously cleared guest address, since the source address 122 may no longer exist (or exist as active) in the guest table 128, the supplicant device 106A may be authorized and authenticated by the system of FIG. 1, as discussed above. In other example embodiments, means other than the hit bit 142 may be used to determine inactivity of the guest addresses.

Traditional 802.1x authentication (e.g., authentication protocol 112) may include a port-based authentication system. For example, under-port based authentication, if a first supplicant device 106A may be provided either the guest access 110A or authenticated access 110B to the network 108 via the physical port 104A, then additional supplicant devices 106B connecting to the network 108 through the physical port 104A may be granted the same access by virtue of the supplicant device 106A. This may, for example, provide a security gap where subsequent supplicant devices 106 connecting through a physical port 104 do not have to be authorized and/or authenticated. The system of FIG. 1 however may provide a device, MAC, or client-based authentication system that may build on the 802.1x protocol by authenticating each client accessing the network 108 rather than each port 104A, 104B of access.

For example, the physical port 104A may be subdivided into multiple logical ports 116A and 116B. Then for example, when an access message 114 is received by the physical port 104A, it may be assigned or otherwise directed to one of the logical ports 116A. The guest authentication system 118 may then grant access to the supplicant device 106A on that logical port 116A as discussed above. Then for example, when a subsequent packet is received by the physical port 104A from a different supplicant device 106B, it may be assigned or otherwise directed to a different logical port 116B, whereby the guest authentication system 118 may then grant different access to the supplicant device 106B than was granted to the supplicant device 106A even though both devices are accessing the network 108 via the same physical port 104A.

This feature of the system of FIG. 1 may be useful in an example embodiment where a hub 146 may be connected to a physical port 104B of the network device 102. The hub 146 may include a network device configured to connect multiple network or supplicant devices (e.g., 106A-C) to the network 108. For example, the hub 146 may include a traditional hub or a voice-over internet protocol (VOIP) phone that has a personal computer or laptop plugged into it. The hub 146 may include authentication protocol 112 compliant and/or non-compliant devices that may or may not be authenticated to access the network 108. Then for example, each supplicant device 106C that tries to access the network 108 via the hub 146 may be treated individually and granted individualized access to the network 108 over the same physical port 104B.

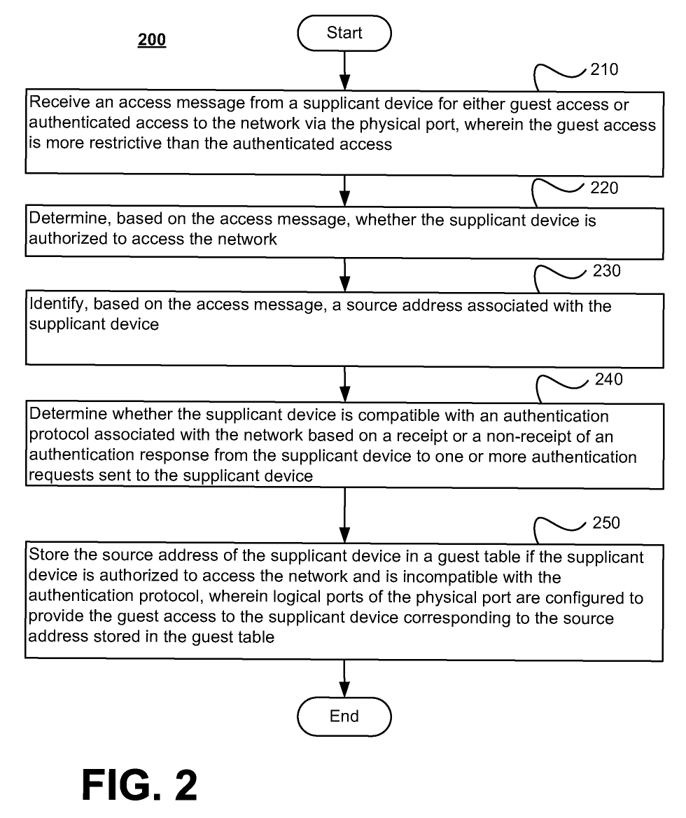

FIG. 2 is a flowchart 200 illustrating example operations of the system of FIG. 1. More specifically, FIG. 2 illustrates an operational flow 200 representing example operations related to a client-based guest VLAN, according to an example embodiment. While FIG. 2 illustrates an example operational flow 200 representing example operations related to the system of FIG. 1, it should be appreciated however that the operational flow 200 is not limited to the example of the system of FIG. 1 and may be applied to other systems.

After a start operation, an access message may be received from a supplicant device, for either guest access or authenticated access to the network via the physical port, wherein the guest access is more restrictive than the authenticated access (210). For example, as shown in FIG. 1, the physical port 104A may receive the access message 114 from the supplicant device 106A for either the guest access 110A or the authenticated access 110B to the network 108.

Based on the access message, it may be determined whether the supplicant device is authorized to access the network (220). For example, the authorization engine 124 may determine whether the supplicant device 106A is authorized to access the network 108.

Based on the access message a source address associated with the supplicant device may be identified (230). For example, the source identifier 120 may identify the source address 122 of the supplicant device 106A.

Whether the supplicant device is compatible with an authentication protocol associated with the network may be determined based on a receipt or a non-receipt of an authentication response from the supplicant device to one or more authentication requests sent to the supplicant device (240). For example, the authentication engine 134 may determine whether the supplicant device 106A is compatible with the authentication protocol 112 associated with the network 108 based on a receipt or non-receipt of the authentication response 140 from the supplicant device 106A to one or more authentication requests 136 sent to the supplicant device 106A.

The source address of the supplicant device may be stored in a guest table if the supplicant device is authorized to access the network and is incompatible with the authentication protocol, wherein logical ports of the physical port are configured to provide the guest access to the supplicant device corresponding to the source address stored in the guest table (250). For example, the guest authentication system 118 may store the source address 122 in the guest table 128 if the supplicant device 106A is authorized to and the authentication engine 134 determines that the supplicant device 106A is incompatible with the authentication protocol 112. Then for example, the logical port 116A may provide guest access 110A to the supplicant device 106A corresponding to the source address 122 stored in the guest table 128.

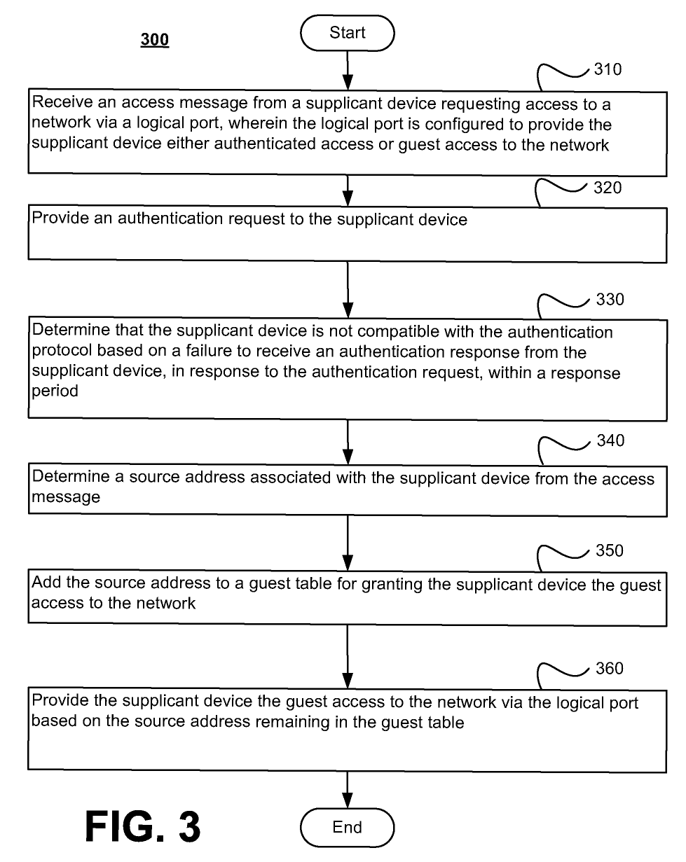

FIG. 3 is a flowchart 300 illustrating example operations of the system of FIG. 1. More specifically, FIG. 3 illustrates an operational flow 300 representing example operations related to a client-based guest VLAN, according to an example embodiment. While FIG. 3 illustrates an example operational flow 300 representing example operations related to the system of FIG. 1, it should be appreciated however that the operational flow 300 is not limited to the example of the system of FIG. 1 and may be applied to other systems.

After a start operation, an access message may be received from a supplicant device requesting access to a network via a logical port, wherein the logical port is configured to provide the supplicant device either authenticated access or guest access to the network (310). For example, as shown in FIG. 1, the physical port 104A may receive the access message 114 to the network 108 via the logical port 116A, wherein the logical port 116A is configured to provide the supplicant device 106A either authenticated access 110B or guest access 110A to the network 108.

An authentication request may be provided to the supplicant device (320). For example, the authentication engine 134 may provide the authentication request 136 to the supplicant device 106A.

The supplicant device may be determined not to be compatible with the authentication protocol based on a failure to receive an authentication response from the supplicant device, in response to the authentication request, within a response period (330). For example, the authentication engine 134 may determine that the supplicant device 106A is not compatible with the authentication protocol 112 based on a failure to receive the authentication response 140 from the supplicant device 106A, in response to the authentication request 136, within a response period as may be determined by the response timer 138.

A source address associated with the supplicant device may be determined from the access message (340). For example, the source identifier 120 may determine the source address 122 associated with the supplicant device 106A from the access message 114.

The source address may be added to a guest table for granting the supplicant device the guest access to the network (350). For example, the guest authentication system 118 may add the source address 122 to the guest table 128 for granting the supplicant device 106A guest access 110A to the network 108.

The supplicant device may be provided the guest access to the network via the logical port based on the source address remaining in the guest table (360). For example, the supplicant device 106A may be provided the guest access 110A to the network 108 via the logical port 116A based on the source address 122 remaining in the guest table 128. As referenced above, for example, the guest access 122 may be periodically cleared from the guest table 128 based on an inactivity associated with the supplicant device 106A as may be determined by the hit bit 142 and the inactivity timer 144.

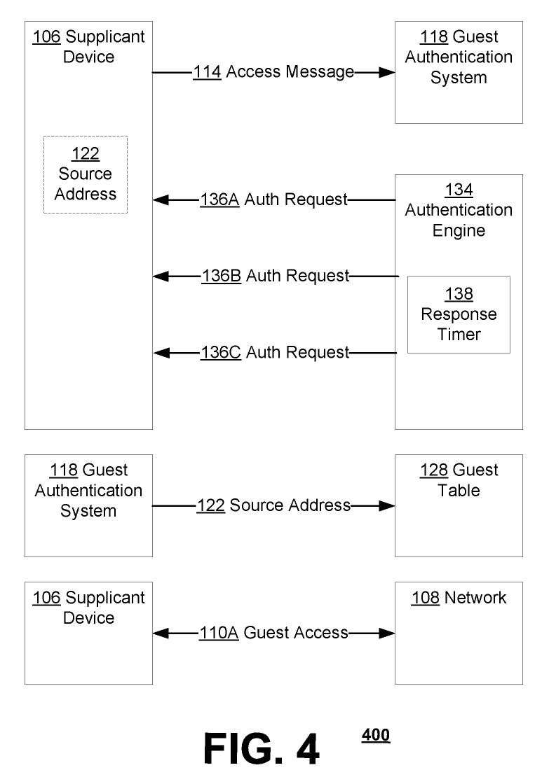

FIG. 4 is a communications diagram 400 illustrating example communications of the components of the system of FIG. 1. More specifically, FIG. 4 illustrates communications 400 representing example operations related providing a supplicant device 106 guest access 110A to a network 108, according to an example embodiment.

The supplicant device 106 may provide the access message 114 to the guest authentication system 118. The guest authentication system 118 may determine the source address 122 of the supplicant device 106 and determine that the supplicant device is authorized to access the network 108.

The authentication engine 134 may send a first authentication request 136A to the supplicant device to authenticate the supplicant device 122 and wait a response period as determined by the response timer 138. After the response period, if no valid authentication response has been received by the authentication engine 134, the authentication engine 134 may send a second authentication request 136B and wait a second response period after which it may send a third authentication request 136C. If, for example, at the expiration of the final response period no authentication response has been received by the authentication engine 134 from the supplicant device 106, then the authentication engine 134 may determine that the supplicant device 106 is not compatible with the authentication protocol. In other example embodiments, there may be fewer or more response periods and/or authentication requests 136A-C before the compatibility determination may be made by the authentication engine 134.

The guest authentication system 118 may determine that guest access 110A is to be granted or provided to the supplicant device 106A. Then for example, the guest authentication system 118 may add the source address 122 of the supplicant device 106 to the guest table 128. Then for example, the supplicant device 106 may be granted the guest access 110A to the network 108 so long as the source address 122 remains in the guest table 128.

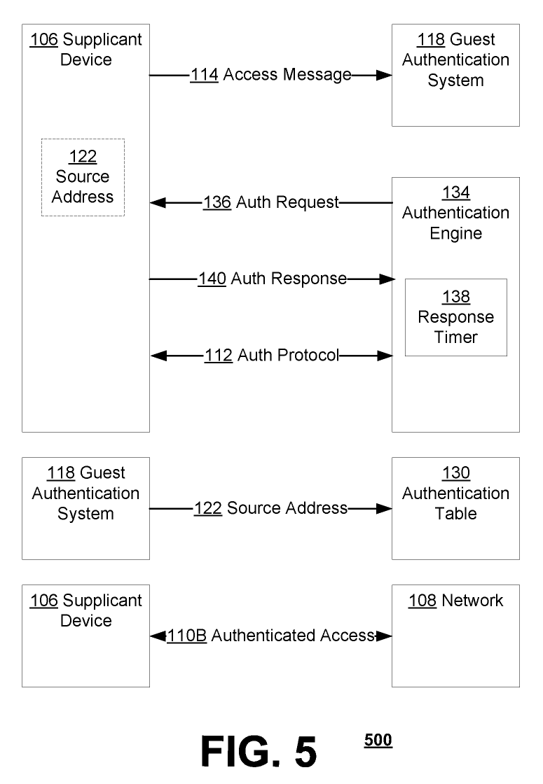

FIG. 5 is a communications diagram 500 illustrating example communications of the components of the system of FIG. 1. More specifically, FIG. 5 illustrates communications 500 representing example operations related providing a supplicant device 106 authenticated access 110B to a network 108, according to an example embodiment.

The supplicant device 106 may provide the access message 114 to the guest authentication system 118. The guest authentication system 118 may determine the source address 122 of the supplicant device 106 and determine whether the supplicant device is authorized to access the network 108.

The authentication engine 134 may send a first authentication request 136A to the supplicant device to authenticate the supplicant device 122 and wait a response period as determined by the response timer 138. The authentication engine 134 may then receive the authentication response 140 from the supplicant device 106 within the response period, indicating that the supplicant device 106 is compatible with the authentication protocol 112. The authentication engine 134 may then run the authentication protocol 112, exchanging messages with the supplicant device 122, to authenticate the supplicant device 106.

The authentication engine 134, as a result of the authentication protocol 112 may authenticate the supplicant device 102. The guest authentication system 118 may determine that authenticated access 110B is to be granted or provided to the supplicant device 106A. The guest authentication system 118 may then add the source address 122 of the supplicant device 122 to the authentication table 130. Then for example, the supplicant device 106 may be granted the authenticated access 110B to the network 108 so long as the source address 122 remains in the authentication table 130.

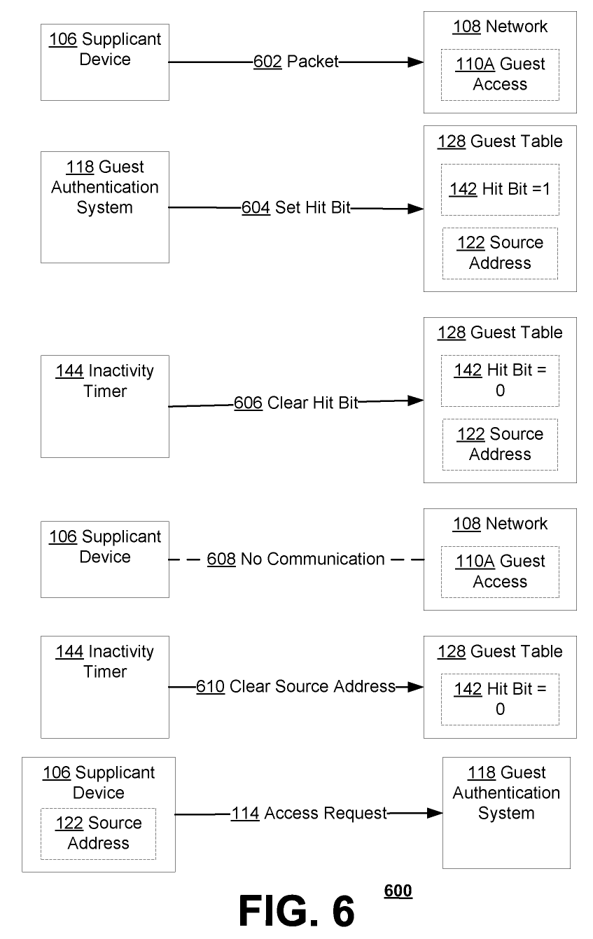

FIG. 6 is a communications diagram 600 illustrating example communications of the components of the system of FIG. 1. More specifically, FIG. 6 illustrates communications 600 representing example operations clearing an inactive source address 122 from the guest table 128, according to an example embodiment.

The supplicant device 106 may provide one or more packets 602 intended for the network 108 where the supplicant device 106 has been granted guest access 110A. The guest authentication system 118 may, at 604, set the hit bit 142 that corresponds to the source address 122 of the supplicant device 106 in the guest table 128 to “1”.

After an inactivity period, as determined by the inactivity timer 144 where no additional packets (e.g., 602) may have been received and/or transmit between the supplicant device 106 and the network 108, the hit bit 142 may be cleared at 606 to “0”. Then for example, after an additional period of non-communication 608 between the supplicant device 106 and network 108, the inactivity timer 144 may expire and clear the source address 122 from the guest table 128.

After the source address 122 has been cleared from the guest table 128, if the supplicant device 106 attempts to access the network (e.g., by sending a packet 602 or access request 114), the source address 124 of the supplicant device 106 may be re-authorized and/or re-authenticated by the guest authentication system 118 prior to being granted the guest access 110A to the network 108.

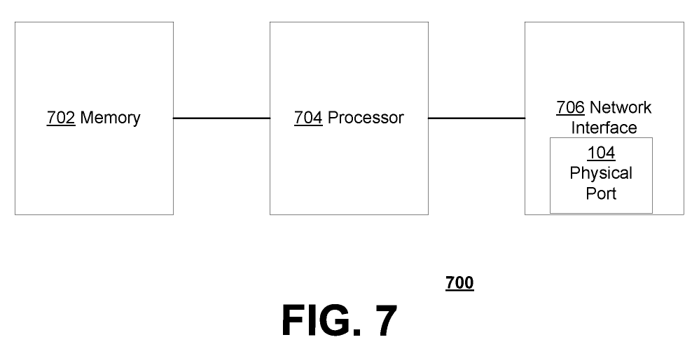

FIG. 7 is a computing system 700 diagram illustrating example components of the client-based guest virtual local area network (VLAN) system of FIG. 1, according to an example embodiment. For example, the components of the computing system 700 may be included within or otherwise associated with the network device (e.g., 102 of FIG. 1).

The computing system 700 may include a memory 702. The memory 702 may include any storage medium that may hold, store or otherwise retrieve software, firmware and/or other code associated with the functionality of the VLAN system. For example, the memory 702 may store the guest table 128 and/or authentication table 130.

A processor 704 may provide overall control and/or execution for the system 700. For example, the processor 704 may execute or otherwise access the information or code stored by the memory 702. According to an example embodiment, the processor 704 may execute the functionality of the guest authentication system 118, as discussed above and including the functionality of its components (e.g., authorization engine 118, source identifier 120, VLAN 126).

A network interface 706 may provide an interface to one or more devices or components. For example, the network interface 706 may provide an interface to a network, such as network 108 (of FIG. 1). The network interface 706 may be configured to allow supplicant devices (e.g., 106) connect to the network by way of the physical port 106, as described above.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A network device connected to a network, the network device comprising:
a physical port configured to receive an access message from a supplicant device, for either guest access or authenticated access to the network via the physical port, wherein the guest access is more restrictive than the authenticated access;
a plurality of logical ports associated with the physical port, wherein each logical port is configured to provide either the guest access or the authenticated access to the supplicant device;
an authorization engine configured to determine, based on the access message, whether the supplicant device is authorized to access the network;
a source identifier configured to identify, based on the access message, a source address associated with the supplicant device;
an authentication engine configured to determine whether the supplicant device is compatible with an authentication protocol associated with the network based on a receipt or a non-receipt of an authentication response from the supplicant device to one or more authentication requests sent to the supplicant device; and
a guest table configured to store the source address of the supplicant device if the supplicant device is authorized to access the network and is incompatible with the authentication protocol, wherein the logical ports are configured to provide the guest access to the supplicant device corresponding to the source address stored in the guest table.

2. The network device of claim 1 wherein the plurality of logical ports are configured to provide the guest access or the authenticated access to the supplicant device based on a virtual local area network associated with the supplicant device.

3. The network device of claim 1 wherein the authentication engine is configured to authenticate the supplicant device based upon the receipt of the authentication response.

4. The network device of claim 1 further comprising an authentication table configured to store the source address of the supplicant device if the supplicant device is authorized to access the network and is compatible with the authentication protocol, wherein the logical ports are configured to provide the authenticated access to the supplicant device corresponding to the source address stored in the authentication table.

5. The network device of claim 1 further comprising an inactivity timer configured to determine when the source addresses of the guest table are cleared from the guest table based on an inactivity period associated with the supplicant device.

6. The network device of claim 1 wherein the guest table includes a hit bit that is associated with the source address in the guest table, and wherein the hit bit identifies whether the source address is to be cleared from the guest table.

7. The network device of claim 1 further comprising an inactivity timer configured to reset a hit bit associated with the source address at the expiration of a first inactivity period, and clear the source address from the guest table at the expiration of a second inactivity period wherein the hit bit remains reset at the expiration of the second inactivity period.

8. The network device of claim 1 wherein the authentication engine includes a response timer configured to determine when a response period for receiving the authentication response has expired.

9. The network device of claim 8 wherein the authentication engine is configured to determine that the supplicant device is not compatible with the authentication protocol based on an expiration of one or more of the response periods wherein the authentication response was not received from the supplicant device within the one or more response periods.

10. A method comprising:
receiving an access message from a supplicant device requesting access to a network via a logical port, wherein the logical port is configured to provide the supplicant device either authenticated access or guest access to the network;
providing an authentication request to the supplicant device;
determining that the supplicant device is not compatible with the authentication protocol based on a failure to receive an authentication response from the supplicant device, in response to the authentication request, within a response period;
determining a source address associated with the supplicant device from the access message;
adding the source address to a guest table for granting the supplicant device the guest access to the network; and
providing the supplicant device the guest access to the network via the logical port based on the source address remaining in the guest table.

11. The method of claim 10 wherein the receiving an access message comprises receiving the access message from each of a plurality of supplicant devices via a physical port associated with the logical port, wherein the physical port is configured to provide the authenticated access or the guest access to the network to each supplicant device, individually, via one or more logical ports associated with the physical port.

12. The method of claim 10 wherein the receiving an access message comprises determining that the supplicant device is authorized to access the network.

13. The method of claim 10 wherein the providing an authentication request comprises providing an extensible authentication protocol (EAP) request to the supplicant device requesting an EAP response from the supplicant device.

14. The method of claim 10 wherein the determining that the supplicant device is not compatible with the authentication protocol comprises:
receiving the authentication response from the supplicant device; and
determining that the authentication response is not compatible with an extensible authentication protocol (EAP).

15. The method of claim 14 wherein the determining a source address comprises:
requesting, via the authentication request, the authentication response from the supplicant device a plurality of times, and waiting the response period in between each authentication request; and
determining that the supplicant device is not compatible with the EAP based on a failure to receive the authentication response within the response period for any of the plurality of authentication requests.

16. The method of claim 10 wherein the determining a source address comprises determining a media access control (MAC) address associated with the supplicant device.

17. The method of claim 10 wherein the adding comprises clearing the source address from the guest table after an expiration of an inactivity period associated with the source address.

18. The method of claim 10 wherein the granting comprises:
receiving a packet associated with the source address;
making a determination that the source address is included in the guest table; and
allowing the packet onto the network based on the determination.

19. A network device comprising a processor, the network device configured to:
interface with a network, the network being associated with an authentication protocol for providing authenticated access or a more restrictive guest access to the network to a supplicant device based on a compatibility of the supplicant device with the authentication protocol;
determine the compatibility of the supplicant device with the authentication protocol; and
provide, via a logical port of a physical port of the network device associated with the supplicant device, the guest access or the authenticated access to the supplicant device based on the compatibility of the supplicant device with the authentication protocol.

20. The switch of claim Error! Reference source not found. further comprising a hub configured to interface with the physical port of the network device, a first supplicant device and a second supplicant device, wherein the network device is configured to provide a first supplicant device with the guest access via a first logical port of the physical port and provide a second supplicant device with the authenticated access via a second logical port of the physical port
